(19) United States
(12) Patent Application Publication
(10) Pub. No.: US 2015/0363850 A1
(43) Pub. Date: Dec. 17, 2015

(54) METHOD FOR PROCESSING ORDER, TRANSACTION SERVER AND COMPUTER READABLE STORAGE MEDIUM

(71) Applicant: Tencent Technology (Shenzhen) Company Limited, Shenzhen (CN)

(72) Inventors: Chongru WANG, Shenzhen (CN); Yanxiang YU, Shenzhen (CN); Liang CHEN, Shenzhen (CN); Jiangtao LI, Shenzhen (CN); Jinhui XIE, Shenzhen (CN); Xueqiong WANG, Shenzhen (CN); Jie BAI, Shenzhen (CN); Zhenming CHEN, Shenzhen (CN); Weihong MO, Shenzhen (CN); Shan LI, Shenzhen (CN); Xiaohua RAN, Shenzhen (CN); Jie CHEN, Shenzhen (CN); Yaohua TAN, Shenzhen (CN); Gan LEI, Shenzhen (CN); Tao HU, Shenzhen (CN); Shufen LUO, Shenzhen (CN); Yafeng TANG, Shenzhen (CN)

(21) Appl. No.: 14/837,962

(22) Filed: Aug. 27, 2015

Related U.S. Application Data
(63) Continuation of application No. PCT/CN2014/072721, filed on Feb. 28, 2014.

(30) Foreign Application Priority Data
Mar. 6, 2013 (CN) 201310071876.0

(51) Int. Cl. G06Q 30/06

(52) U.S. Cl. CPC G06Q 30/0611; G06Q 30/0633

(57) ABSTRACT

The present disclosure provides a method for processing a transaction order of virtual resources. The order for the virtual resources is received by a server from a first client, and the order records a specified quantity of the virtual resources to be purchased. All commodities including the virtual resources offered for sale are acquired from a database of a transaction system. All the commodities are traversed to select a commodity combination matching the specified quantity. The commodity combination comprises one or more of the commodities. A corresponding suborder is generated for each commodity in the selected commodity combination. The suborder is processed according to demand. Also provided are a transaction server and a computer readable storage medium.

### CROSS-REFERENCE TO RELATED APPLICATION

The present disclosure is a continuous application of International Application No. PCT/CN2014/072721, titled “METHOD FOR PROCESSING ORDER, TRANSACTION SERVER AND COMPUTER READABLE STORAGE MEDIUM”, filed on Feb. 28, 2014, which claims priority to Patent Application No. 201310071876.0, titled “METHOD AND APPARATUS FOR PROCESSING TRANSACTION ORDER OF VIRTUAL RESOURCE”, filed on Mar. 6, 2013, with the Chinese Patent Office, both of which are incorporated herein by reference in their entirety.

### FIELD OF THE TECHNOLOGY

The present disclosure relates to the field of network data processing technologies, and in particular, to a method for processing a transaction order of virtual resources, a transaction server, and a computer readable storage medium.

BACKGROUND OF THE DISCLOSURE

In an existing transaction system, such as an auction house or a consignment shop set up in an online gaming environment, virtual currencies are in circulation only in the online gaming environment, and a seller can sell commodities composed of virtual resources such as 1000 game currencies. A buyer in need for specific quantity of virtual resources may purchase several commodities composed of the virtual resources.

Due to randomness in the desired quantity of virtual resources, the buyer needs to manually search for commodities that can be combined to satisfy the desired quantity of the virtual resources before placing an order on each commodity. The transaction system needs to perform settlement for each received order on commodities, and thus needs to perform settlement a number of times, resulting in low efficiency in processing the orders.

### SUMMARY

In view of this, it is provided a method for processing a transaction order of virtual resources, a transaction server, and a computer readable storage medium, which can automatically select, according to a specified quantity of virtual resources to be purchased in a transaction system, a commodity combination matching the specified quantity from all commodities including the virtual resources which are offered for sale, for a buyer to purchase, so as to improve efficiency of processing a transaction order of the virtual resources.

A method for processing a transaction order of virtual resources includes: receiving an order for the virtual resources, the order recording a specified quantity of the virtual resources to be purchased; acquiring all commodities including the virtual resources which are offered for sale from a database of a transaction system; traversing all the commodities and selecting a commodity combination matching the specified quantity, the commodity combination including one or more of the commodities; and generating a corresponding suborder for each commodity in the selected commodity combination, and processing the suborder according to demand.

A transaction server for processing a transaction order of virtual resources, includes: a memory; one or more processors; and a plurality of modules stored in the memory and configured to be executed by the one or more processors, the plurality of modules including: a receiving module, configured to receive an order for the virtual resources, the order recording a specified quantity of the virtual resources to be purchased; an acquiring module, configured to acquire all commodities including the virtual resources which are offered for sale from a database of a transaction system; a selection module, configured to traverse all the commodities and select a commodity combination matching the specified quantity, the commodity combination including one or more of the commodities; and a processing module, configured to generate a corresponding suborder for each commodity in the selected commodity combination, and process the suborder according to demand.

A computer readable storage medium stores one or more programs, the one or more programs including instructions, which cause a server to perform a method when being executed by the server, and the method including the following steps: receiving an order for the virtual resources, the order recording a specified quantity of the virtual resources to be purchased; acquiring all commodities including the virtual resources which are offered for sale from a database of a transaction system; traversing all the commodities and selecting a commodity combination matching the specified quantity, the commodity combination including one or more of the commodities; and generating a corresponding suborder for each commodity in the selected commodity combination, and processing the suborder according to demand.

Compared with the existing technology, in the present disclosure, according to a specified quantity of virtual resources to be purchased in a transaction system, a commodity combination that matches the specified quantity and whose average unit price or sale price satisfies requirements can be automatically selected from all commodities including the virtual resources which are offered for sale, for a buyer to purchase, so as to improve efficiency of processing a transaction order of the virtual resources.

To make the foregoing and other objectives, features, and advantages of the present disclosure more comprehensible, preferred embodiments are described in detail below with reference to the accompanying drawings.

### BRIEF DESCRIPTION OF THE DRAWINGS

FIG. 1 is a schematic diagram of an electronic transaction system for a virtual resource;

FIG. 2 is a structural block diagram of a client in the electronic transaction system in FIG. 1;

FIG. 3 is a structural block diagram of a transaction server in the electronic transaction system in FIG. 1;

FIG. 4 is a diagram of functional modules of an apparatus for processing a transaction order of virtual resources according to a first embodiment of the present invention;

FIG. 5 is a diagram of functional modules of an apparatus for processing a transaction order of virtual resources according to a second embodiment of the present invention;

FIG. 6 is a flowchart of a method for processing a transaction order of virtual resources according to a third embodiment of the present invention;

FIG. 7 is a flowchart of a method for processing a transaction order of virtual resources according to a fourth embodiment of the present invention;

FIG. 8 is a schematic flowchart of processing a transaction order of virtual resources in a fourth embodiment; and

FIG. 9 is a schematic diagram of interaction between a front page and a database of a transaction system in FIG. 8.

### DESCRIPTION OF EMBODIMENTS

To further explain the technical means used in the present disclosure for achieving the intended objectives and the effects thereof, specific implementation manners, structures, features, and effects of a method of information feedback and a corresponding server that are provided according to the present disclosure are described in detail below with reference to the accompanying drawings and preferred embodiments.

The foregoing and other technical content, features, and effects related to the present disclosure can be clearly presented in the detailed description of the preferred embodiments with reference to the drawings. Through the description of the specific implementation manners, the technical means used in the present disclosure for achieving the intended objectives and the effects can be understood more deeply and specifically. However, the accompanying drawings are merely provided for reference and description rather than limiting the present disclosure.

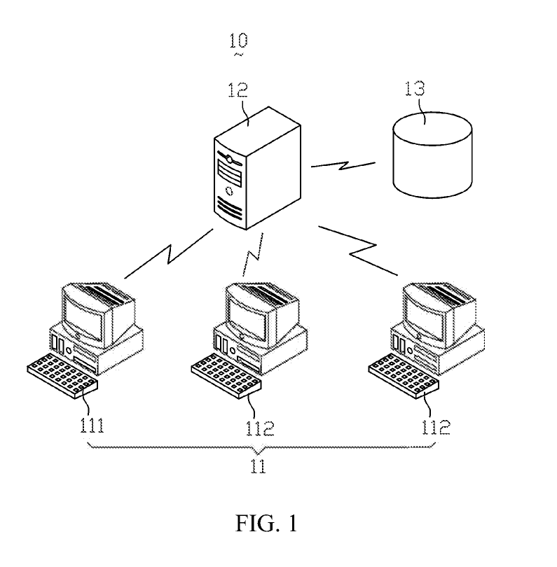

FIG. 1 is a schematic diagram of an electronic transaction system used for virtual resource transaction. The electronic transaction system 10 includes clients 11, a transaction server 12, and a database 13. Examples of the clients 11 include, but are not limited to, personal computers, tablet computers, mobile phones, and the like. The clients 11 each may run a browser or another application program and access, via a network, a virtual resource transaction service provided by the transaction server 12. In the embodiment, the clients 11 may include a first client 111 and multiple second clients 112. The first client 111 is logged in by a virtual resource purchaser, and the second clients 112 are logged in by multiple virtual resource sellers respectively.

The transaction server 12 may be a single server and may also be a server cluster to provide an electronic transaction service of virtual resources for the clients in a distributed architecture. For example, the transaction server 12 may provide interfaces of the electronic transaction system according to requests, for presentation by the clients 11, and provides, in the interface, entrances for the user to perform functions such as purchasing or selling the virtual resources. The user sends to the transaction server 12 by using various interfaces in the client 11, requests (that is, orders) for purchasing or selling the virtual resources.

The transaction server 12 further stores request data from the client 11 in the database 13, so as to match requests of the seller and the purchaser in a subsequent transaction process.

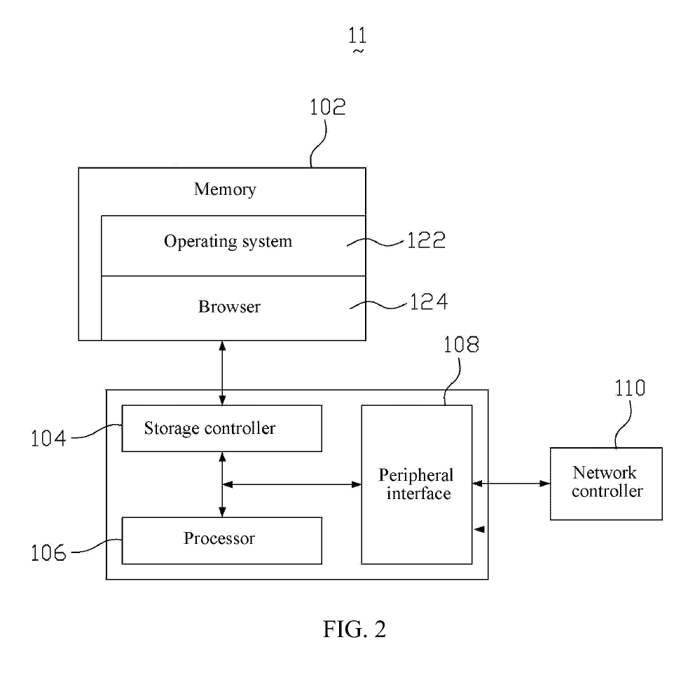

FIG. 2 is a structural block diagram of an embodiment of the client 11. As shown in FIG. 2, the client 11 includes: a memory 102, a storage controller 104, one or more processors 106 (only one processor is shown in the figure), a peripheral interface 108, and a network controller 110. It may be understood that the structure shown in FIG. 2 is merely exemplary and does not constitute any limitation to the structure of the client 11. For example, the client 11 may also include more or fewer components than those shown in FIG. 2, or have a configuration different from that shown in FIG. 2.

The memory 102 may be configured to store a software program or modules, such as program instructions/modules corresponding to the method and the apparatus in the embodiments of the present invention. The processor 106 runs the software program and modules stored in the memory 102, to implement various functions and data processing, that is, implement the foregoing method.

The memory 102 may include a high-speed random access memory, and may also include a non-volatile memory such as one or more magnetic storage, a flash memory, or another non-volatile solid-state memory. In some embodiments, the memory 102 may further include memories remotely disposed relative to the processor 106, and these remote memories may be connected to the client 11 by using a network. Examples of the network include, but are not limited to, the Internet, an intranet, a local area network, a mobile communications network, and a combination thereof. The processor 106 and other possible components may access the memory 102 under the control of the storage controller 104.

The peripheral interface 108 couples various input/output apparatuses to the processor 106. The processor 106 runs various types of software stored in the memory 102, to instruct the computing apparatus 100 to perform different functions and perform data processing. In some embodiments, the peripheral interface 108, the processor 106, and the storage controller 104 may be implemented in a single chip. In some other embodiments, they may be separately implemented by independent chips.

The network controller 110 is configured to receive and send network signals. The network signals may include wireless signals or wired signals. In an embodiment, the network signals are wired network signals. In this case, the network controller 110 may include components such as a processor, a random access memory, a converter, and a crystal oscillator.

The software program and modules include: an operating system 122 and a browser 124. The operating system 122, for example, may be LINUX, UNIX, or WINDOWS, which may include various software components and/or drivers configured to manage system tasks (such as memory management, storage device control, and power supply management), and may communicate with various hardware or software components, so as to provide a running environment for other software components. The browser 124 runs based on the operating system 122, and can access the transaction server 12 to acquire and display a front page of the electronic transaction system, and send a request for selling or purchasing the virtual resources to the transaction server 12 after the user completes a predetermined input operation.

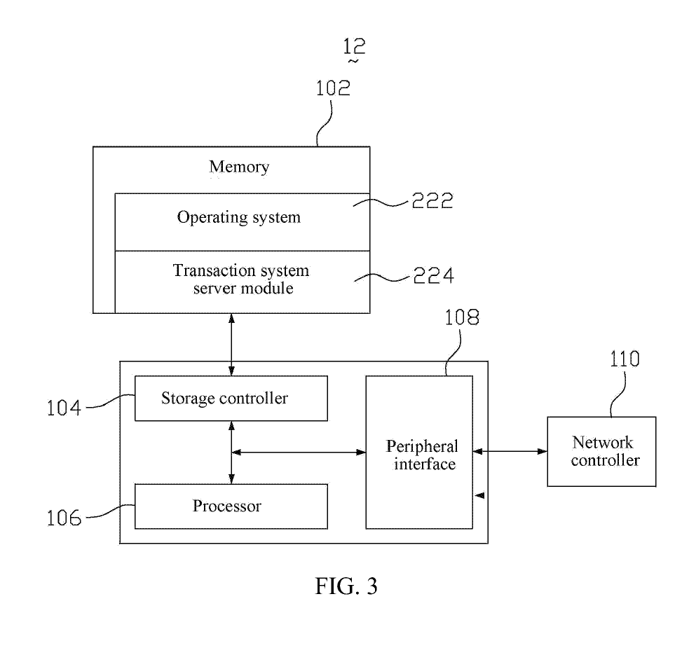

FIG. 3 is a structural block diagram of an embodiment of the transaction server 12. As shown in FIG. 3, the structure of the transaction server 12 is similar to that of the client 11, differing only in software programs and modules running in the transaction server 12. It is understood that the client 11 generally is a personal computer, and the transaction server 12 is generally and exclusively used as a server. Therefore, although the two have similar architectures, specific hardware models and performance are different.

The software programs in the transaction server 12 include an operating system 222 and a transaction system server module 224. The operating system 222, for example, may be a server version of LINUX, UNIX, or WINDOWS, may include various software components and/or drivers configured to manage system tasks (such as memory management, storage device control, and power supply management), and may communicate with various hardware or software components, so as to provide a running environment for other software components. The transaction system server module 224 runs in the operating system 122, sends back, in response to the request of the client 11, interfaces of the electronic transaction system to be displayed by the client 11, and provides entrances on the interfaces for the user to perform functions such as purchasing or selling the virtual resources. The user sends requests (i.e., orders) for purchasing or selling the virtual resources to the transaction server 12 by using various interfaces in the client 11. The transaction system server module 224 processes these requests accordingly. A specific process implemented in the transaction server 12 is described below with reference to embodiments.

### First Embodiment

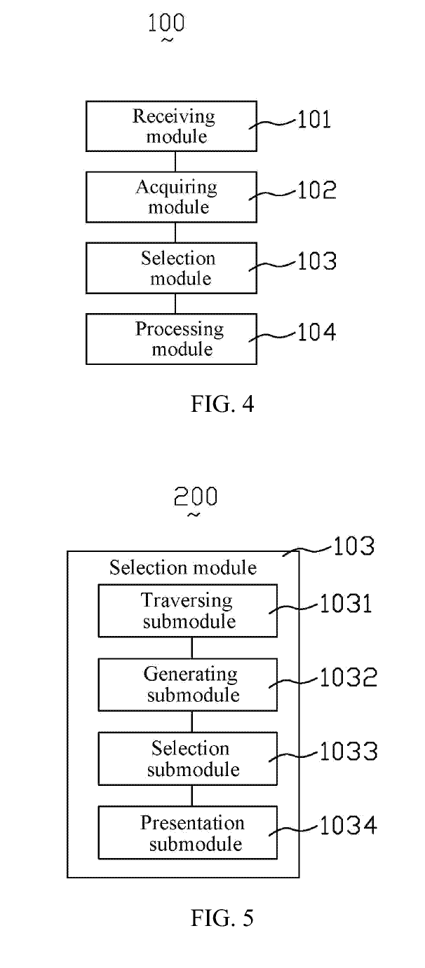

Refer to FIG. 4, which is a diagram of functional modules of an apparatus 100 for processing a transaction order(s) of virtual resources according to the first embodiment of the present invention. The apparatus 100 for processing a transaction order of virtual resources is implemented in the transaction server 12 and includes a receiving module 101, an acquiring module 102, a selection module 103, and a processing module 104. It may be understood that the foregoing modules refer to computer programs or program fragments and are configured to perform one or more specific functions, Moreover, distinction between the foregoing modules does not represent that actual program codes are also necessarily separate.

The receiving module 101 is configured to receive an order for the virtual resources from the first client 111, the order recording a specified quantity of the virtual resources to be purchased. The virtual resources may be virtual currencies in circulation in an online game such as game currencies or reward points. A buyer can select a specified quantity of the virtual resources that the buyer needs to purchase on a front page of a transaction system such as an auction house or a consignment shop in the online game, so as to submit an order for purchasing the specified quantity of the virtual resources to the transaction system.

The acquiring module 102 is configured to acquire all commodities including the virtual resources offered for sale from a database of the transaction system. The commodity is composed of one or more of the virtual resources. For example, a first commodity includes 1000 virtual resources, and a second commodity includes 500 virtual resources, or the like.

The selection module 103 is configured to traverse and browse all the commodities and select a commodity combination matching the specified quantity, the commodity combination including one or more of the commodities. Matching the specified quantity means that the quantity of the virtual resources in the commodity combination falls in a preset quantity range, and that the preset quantity range is equal to the specified quantity plus/minus a first preset value.

The processing module 104 is configured to generate a corresponding suborder for each commodity in the selected commodity combination, and perform processing according to demand. Specifically, because commodities in the selected commodity combination may be published and sold by different sellers, the corresponding suborder needs to be separately generated for each commodity. Then the generated suborders are submitted to respective sellers through the second clients 112, so as to complete fund settlement with the respective sellers.

In conclusion, the apparatus 100 for processing a transaction order(s) of virtual resources provided by this embodiment can automatically select, according to the specified quantity of virtual resources to be purchased in the transaction system, a commodity combination matching the specified quantity from all commodities including the virtual resources offered for sale, for a buyer to purchase, so as to improve efficiency of processing a transaction order of the virtual resources.

### Second Embodiment

The apparatus 100 for processing a transaction order of virtual resources provided by the first embodiment automatically selects a commodity combination matching the specified quantity, for a buyer to purchase; therefore, the efficiency of processing the transaction order of the virtual resources can be improved. However, different sellers may set different unit prices for the same commodity, leading to different prices of the commodity combinations matching the specified quantity. Therefore, the commodity combination selected by the apparatus 100 for processing a transaction order of virtual resources provided by the first embodiment may not satisfy needs of the transaction system or the buyer.

In order to further solve the foregoing problem, referring to FIG. 5, the second embodiment provides an apparatus 200 for processing a transaction order(s) of virtual resources. The apparatus 200 is implemented in the transaction server 12. As compared with the apparatus 100 for processing a transaction order of virtual resources provided by the first embodiment, the selection module 103 further includes the following submodules.

A traversing submodule 1031 is configured to traverse and browse all the commodities and acquire the quantity of the virtual resources in each commodity.

A generating submodule 1032 is configured to generate, according to the quantity of the virtual resources in each commodity, a plurality of commodity combinations matching the specified quantity, where each of the commodity combinations includes one or more of the commodities. Matching the specified quantity means that the quantity of the virtual resources in a commodity combination falls in a preset quantity range and the preset quantity range is equal to the specified quantity plus/minus a first preset value.

A selection submodule 1033 is configured to select one commodity combination from the plurality of commodity combinations matching the specified quantity.

Specifically, in order to enable each buyer to purchase a low-unit-price commodity for a profit-share and preventing a high-unit-price commodity from being unsalable, a commodity combination whose average unit price falls in a preset unit price range may be selected, where the preset unit price range is equal to an average unit price of all the commodities including the virtual resources offered for sale plus/minus a second preset value.

Moreover, from a perspective that buyers all hope to purchase the same commodity at the lowest price, a commodity combination whose sale price is the lowest may be selected from all the commodity combinations matching the specified quantity.

A presentation submodule 1034 is configured to present the average unit price or a sale price of the selected commodity combination, and a quantity of the virtual resources for sale to a buyer for review.

Because the quantity of the virtual resources for sale in the selected commodity combination may be inconsistent with the specified quantity, the quantity of the virtual resources for sale in the selected commodity combination may be presented to the buyer for consideration.

If a commodity combination whose average unit price falls in the preset unit price range is selected, the average unit price of the selected commodity combination may be further presented. If a commodity combination whose sale price is the lowest among all the commodity combinations matching the specified quantity is selected, the sale price of the selected commodity combination may be further presented, and then the buyer determines whether to purchase the selected commodity combination.

When the buyer determines to purchase the selected commodity combination, the processing module 104 in the first embodiment generates a corresponding suborder for each commodity in the selected commodity combination, and performs processing according to demand.

In conclusion, the apparatus 200 for processing a transaction order of virtual resources provided by this embodiment may further select a commodity combination whose average unit price or sale price satisfies requirements from all the commodity combinations matching the specified quantity, for a buyer to purchase. If a commodity combination whose average unit price falls in the preset unit price range is selected, a problem that some high-unit-price commodities in the transaction system are unsalable can be solved, and all buyers may purchase a low-unit-price commodity for a profit-share, which is beneficial to maintaining economic stability of the transaction system. If a commodity combination whose sale price is the lowest in all the commodity combinations matching the specified quantity is selected, a technical problem that the buyers hope to purchase a selected commodity combination at the lowest price can be solved.

### Third Embodiment

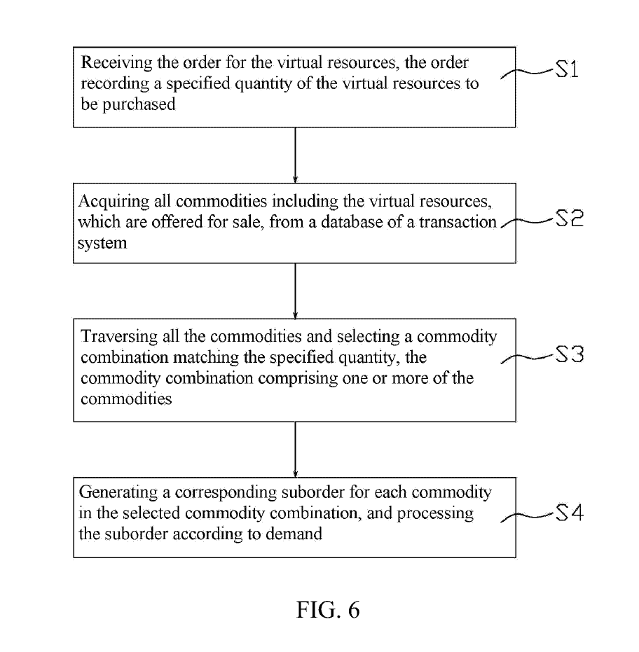

Refer to FIG. 6, which is a flowchart of a method for processing a transaction order(s) of virtual resources according to the third embodiment of the present invention. With reference to the apparatus 100 for processing a transaction order of virtual resources provided by the first embodiment of the present invention, the method for processing a transaction order of virtual resources includes the following steps S1-S4.

At step S1, the receiving module 101 receives an order for the virtual resources from the first client 111, the order recording a specified quantity of the virtual resources to be purchased.

At step S2, the acquiring module 102 acquires all commodities including the virtual resources offered for sale from a database of a transaction system.

At step S3, the selection module 103 traverses and browses all the commodities and selects one commodity combination matching the specified quantity, the commodity combination including one or more of the commodities.

At step S4, the generating module 104 generates a corresponding suborder for each commodity in the selected commodity combination, and performs processing according to demand.

In conclusion, according to the method for processing a transaction order of virtual resources provided by this embodiment, according to a specified quantity of virtual resources to be purchased in a transaction system, a commodity combination matching the specified quantity can be automatically selected from all commodities including the virtual resources offered for sale, for a buyer to purchase, so as to improve efficiency of processing a transaction order of the virtual resources.

### Fourth Embodiment

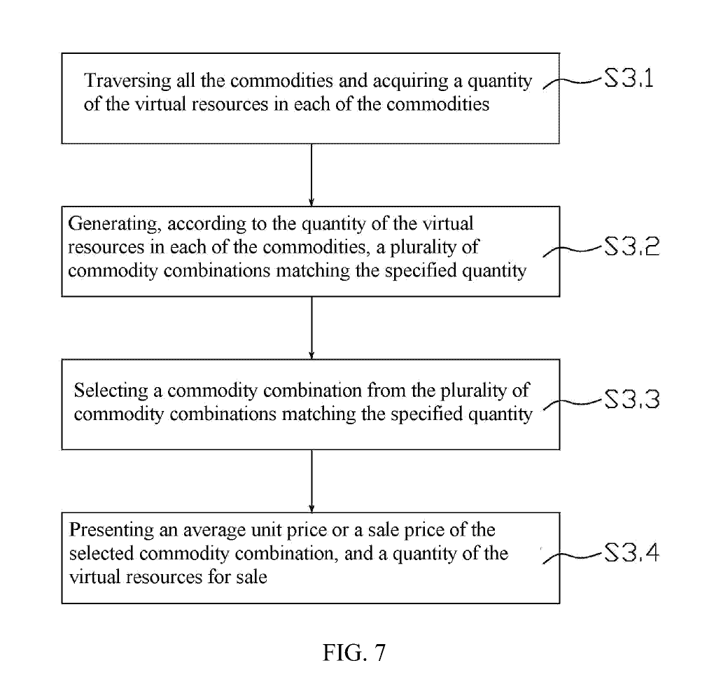

Referring to FIG. 7, the fourth embodiment provides a method for processing a transaction order(s) of virtual resources. As compared with the method for processing a transaction order of virtual resources in the third embodiment, with reference to the apparatus 200 for processing a transaction order of virtual resources provided by the second embodiment of the present invention, the foregoing step S3 further includes the following steps S3.1-S3.4.

At step S3.1, the traversing submodule 1031 traverses and browses all the commodities and acquires a quantity of the virtual resources in each commodity.

At step S3.2, the generating submodule 1032 generates, according to the quantity of the virtual resources in each commodity, a plurality of commodity combinations matching the specified quantity, where the commodity combination includes one or more of the commodities. And matching the specified quantity may be understood as that: the quantity of the virtual resources in the commodity combination falls in a preset quantity range, and the preset quantity range is equal to the specified quantity plus/minus a first preset value.

At step S3.3, the selection submodule 1033 selects a commodity combination from the plurality of commodity combinations matching the specified quantity. The selection submodule 1033 may select a commodity combination whose average unit price falls in a preset unit price range, where the preset unit price range is equal to an average unit price of all the commodities including the virtual resources offered for sale plus/minus a second preset value. The selection submodule 1033 may also select a commodity combination whose sale price is the lowest from all the commodity combinations matching the specified quantity.

At step S3.4, the presentation submodule 1034 presents an average unit price or a sale price of the selected commodity combination, and a quantity of the virtual resources for sale for a buyer to review.

In conclusion, according to the method for processing a transaction order of virtual resources provided by this embodiment, a commodity combination whose average unit price or sale price satisfies requirements may be further selected from all the commodity combinations matching the specified quantity, for a buyer to purchase.

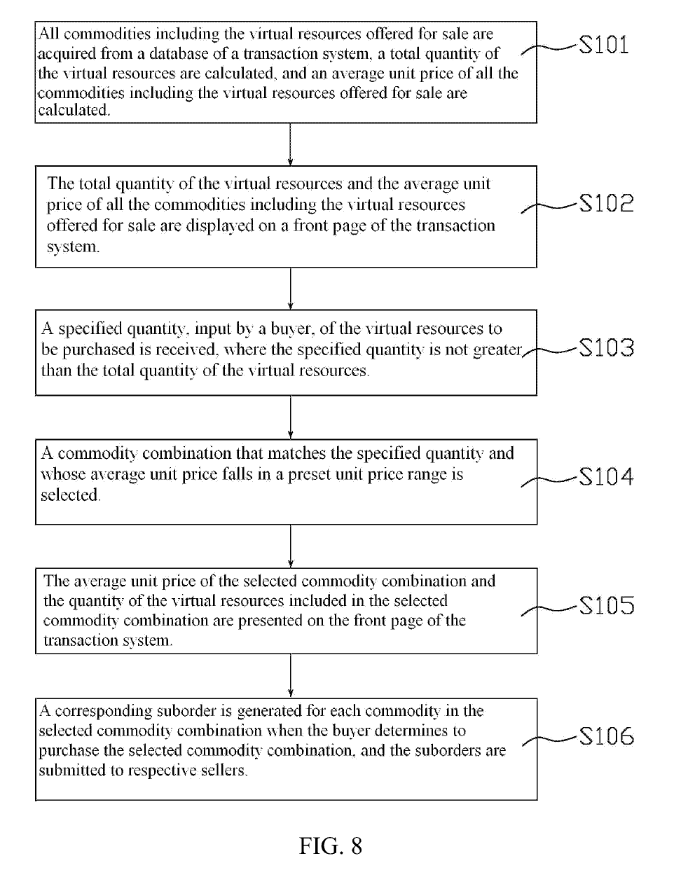

Refer to FIG. 8, which is a flowchart of an example of processing a transaction order(s) of virtual resources in the fourth embodiment.

At step S101, all commodities including the virtual resources offered for sale are acquired from a database of a transaction system, a total quantity of the virtual resources are calculated, and an average unit price of all the commodities including the virtual resources offered for sale are calculated.

At step S102, the total quantity of the virtual resources and the average unit price of all the commodities including the virtual resources offered for sale are displayed on a front page of the transaction system.

At step S103, a specified quantity, input by a buyer, of the virtual resources to be purchased is received, where the specified quantity is not greater than the total quantity of the virtual resources.

At step S104, a commodity combination that matches the specified quantity and whose average unit price falls in a preset unit price range is selected, where the preset unit price range is equal to the average unit price of all the commodities including the virtual resources offered for sale plus/minus a second preset value.

For example, the specified quantity is N; the average unit price of all the commodities including the virtual resources offered for sale is P; and the selected commodity combination includes the following commodities:

commodity 1: including N1 virtual resources, and an unit price being P1;

commodity 2: including N2 virtual resources, and an unit price being P2; . . .

commodity λ: including Nλ virtual resources, and an unit price being Pλ.

The quantity Ns of the virtual resources for sale in the selected commodity combination is equal to N1+N2+ . . . +Nλ, and the average unit price Pa of the selected commodity combination is equal to (P1+P2+ . . . +Pλ)/(N1+N2+ . . . +Nλ), where the range of Ns is N plus/minus a first preset value, and the range of Pa is P plus/minus a second preset value.

At step S105, the average unit price of the selected commodity combination and the quantity of the virtual resources included in the selected commodity combination are presented on the front page of the transaction system, so that the buyer determines whether to purchase the selected commodity combination.

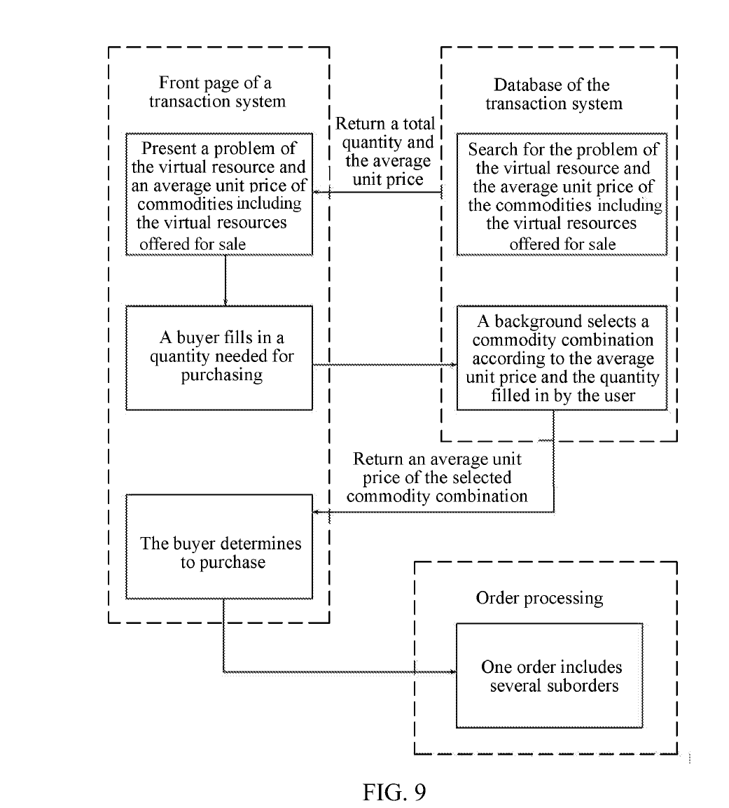

At step S106: a corresponding suborder is generated for each commodity in the selected commodity combination when the buyer determines to purchase the selected commodity combination, and the suborders are submitted to respective sellers, so as to complete fund settlement with the respective sellers. FIG. 9 is a schematic diagram of interaction between the front page and the database in the transaction system in FIG. 8.

Moreover, an embodiment of the present invention further provides a computer readable storage medium, storing computer executable instructions. The computer readable storage medium may be a non-volatile memory such as an optical disc, a hard disk or a flash memory. The computer executable instructions are used for enabling a computer or a similar computing apparatus to complete various operations in the foregoing method for processing a transaction order of virtual resources.

The foregoing descriptions are merely embodiments of the present invention, and are not intended to limit the present disclosure in any form. Although the present disclosure has been disclosed above through the embodiments, the embodiments are not intended to limit the present disclosure. A person skilled in the art can make some equivalent variations, alterations or modifications to the above-disclosed technical content without departing from the scope of the technical solutions of this application to obtain equivalent embodiments. Any simple alteration, equivalent change or modification made to the above embodiments according to the technical essence of the present disclosure without departing from the content of the technical solutions of this application shall fall within the scope of the technical solutions of the present disclosure.

### INDUSTRIAL APPLICABILITY

In the foregoing solutions, according to a specified quantity of virtual resources to be purchased in a transaction system, a commodity combination matching the specified quantity can be automatically selected from all commodities including the virtual resources offered for sale, for a buyer to purchase, so as to improve efficiency of processing a transaction order of the virtual resources.

What is claimed is:

1. A method for processing a transaction order of virtual resources, comprising:
receiving, by a server including at least one processor and a memory, the transaction order for the virtual resources, the transaction order recording a specified quantity of the virtual resources to be purchased;
acquiring, by the server, all commodities including the virtual resources, which are offered for sale, from a database of a transaction system;
traversing, by the server, all the commodities and selecting a commodity combination matching the specified quantity, the commodity combination comprising one or more of the commodities; and
generating a corresponding suborder for each commodity in the selected commodity combination, and processing the suborder according to demand.

2. The method according to claim 1, wherein a quantity of the virtual resources in the commodity combination matching the specified quantity falls in a preset quantity range, and the preset quantity range is equal to the specified quantity plus/minus a first preset value.

3. The method according to claim 2, further comprises:
traversing, by the server, all the commodities and acquiring a quantity of the virtual resources in each of the commodities;
generating, by the server, according to the quantity of the virtual resources in each of the commodities, a plurality of commodity combinations matching the specified quantity; and
selecting, by the server, a commodity combination from the plurality of commodity combinations matching the specified quantity.

4. The method according to claim 3, wherein an average unit price of the selected commodity combination falls in a preset unit price range, and the preset unit price range is equal to an average unit price of all the commodities including the virtual resources which are offered for sale plus/minus a second preset value.

5. The method according to claim 3, wherein a sale price of the selected commodity combination is the lowest among the plurality of commodity combinations matching the specified quantity.

6. The method according to claim 1, further comprising:
presenting an average unit price or a sale price of the selected commodity combination, and a quantity of the virtual resources for sale.

7. A transaction server for processing a transaction order of virtual resources, and comprising:
a memory;
one or more processors; and
the memory having code stored therein, when the one or more processors execute the code the one or more processors are configured into a plurality of modules comprising:
a receiving module, configured to receive the order for the virtual resources, the order recording a specified quantity of the virtual resources to be purchased;
an acquiring module, configured to acquire all commodities including the virtual resources which are offered for sale from a database of a transaction system;
a selection module, configured to traverse all the commodities and select a commodity combination matching the specified quantity, the commodity combination comprising one or more of the commodities; and
a processing module, configured to generate a corresponding suborder for each commodity in the selected commodity combination, and process the suborder according to demand.

8. The transaction server according to claim 7, wherein a quantity of the virtual resources in the commodity combination matching the specified quantity falls in a preset quantity range, and the preset quantity range is equal to the specified quantity plus/minus a first preset value.

9. The transaction server according to claim 8, wherein the selection module comprises:
a traversing submodule, configured to traverse all the commodities and acquire a quantity of the virtual resources in each of the commodities;
a generating submodule, configured to generate, according to the quantity of the virtual resources in each of the commodities, a plurality of commodity combinations matching the specified quantity; and
a selection submodule, configured to select a commodity combination from the plurality of commodity combinations matching the specified quantity.

10. The transaction server according to claim 9, wherein an average unit price of the selected commodity combination falls in a preset unit price range, and the preset unit price range is equal to an average unit price of all the commodities including the virtual resources which are offered for sale plus/minus a second preset value.

11. The transaction server according to claim 9, wherein a sale price of the selected commodity combination is the lowest among the plurality of commodity combinations matching the specified quantity.

12. The transaction server according to claim 7, wherein the selection module is further configured to present an average unit price or a sale price of the selected commodity combination, and a quantity of the virtual resources for sale.

13. A computer readable storage medium, storing one or more programs, the one or more programs comprising instructions, which cause a server to perform a method when being executed by the server, and the method comprising:
receiving the order for the virtual resources, the order recording a specified quantity of the virtual resources to be purchased;
acquiring all commodities including the virtual resources which are offered for sale, from a database of a transaction system;
traversing all the commodities and selecting a commodity combination matching the specified quantity, the commodity combination comprising one or more of the commodities; and
generating a corresponding suborder for each commodity in the selected commodity combination, and processing the suborder according to demand.

14. The computer readable storage medium according to claim 13, wherein a quantity of the virtual resources in the commodity combination matching the specified quantity falls in a preset quantity range, and the preset quantity range is equal to the specified quantity plus/minus a first preset value.

15. The computer readable storage medium according to claim 14, wherein the step of traversing all the commodities and selecting a commodity combination matching the specified quantity comprises:
traversing all the commodities and acquiring a quantity of the virtual resources in each of the commodities;
generating, according to the quantity of the virtual resources in each of the commodities, a plurality of commodity combinations matching the specified quantity; and
selecting a commodity combination from the plurality of commodity combinations matching the specified quantity.

16. The computer readable storage medium according to claim 15, wherein an average unit price of the selected commodity combination falls in a preset unit price range, and the preset unit price range is equal to an average unit price of all the commodities including the virtual resources which are offered for sale plus/minus a second preset value.

17. The computer readable storage medium according to claim 15, wherein a sale price of the selected commodity combination is the lowest among the plurality of commodity combinations matching the specified quantity.

18. The computer readable storage medium according to claim 13, wherein before the generating a corresponding suborder for each commodity in the selected commodity combination, the method further comprises:
presenting an average unit price or a sale price of the selected commodity combination, and a quantity of the virtual resources for sale.
